(19) United States
(12) Patent Application Publication
(10) Pub. No.: US 2005/0276896 A1
(43) Pub. Date: Dec. 15, 2005

(54) Formulation providing a low carbohydrate cereal based system including a novel dough and a pizza crust or bread product having open cell structure

(76) Inventors: Nagwa Zaki Sadek, Ypsilanti, MI (US); Mohamed M. Morad, Marshall, MN (US); David C. Rettey, Tracy, MN (US); Bhajmohan Singh, Marshall, MN (US)

Correspondence Address: Merchant & Gould P.C., P.O. Box 2903, Minneapolis, MN, 55402-0903, US

(21) Appl. No.: 10/868,190

(22) Filed: Jun. 14, 2004

(51) Int. Cl. A23L 1/28

(52) U.S. Cl. 426/549

(57) ABSTRACT

A novel dough composition for improved dough can be used to produce a baked, high protein, low carbohydrate bread product. The formulation and process can be used to make low carbohydrate dough that can be used to manufacture bread and other bread-like products of high quality and consumer acceptance. The bread is characterized by low nutritive carbohydrate content, bread-like open cell structure and a high quality nutrition, texture and flavor. The dough comprises an aqueous leavened dispersion that comprises an effective but low amount of wheat flour for texture and flavor, an effective amount of gluten, in excess of the flour content, and an effective amount of a protein source along with an effective amount of an edible fiber to provide high protein content, low carbohydrate content and bread-like texture.

### FIELD OF THE INVENTION

The invention relates to a formulation and process that can be used to make a nutritious, low carbohydrate cereal based system. The low carbohydrate system can be used to manufacture a dough and from the dough a bread, pizza crust or other bready products of high quality and consumer acceptance. The nutritious system is characterized by low nutritive carbohydrate content, bread-like open cell structure, bready texture and flavor. The product of the invention solves many of the flavoring and texture problems inherent in prior art low carbohydrate formulations that are based primarily on soy products, fiber, high protein sources or simply reduced weight formulations such as thin or cracker-like crusts. In sharp contrast to prior art materials, the product of the invention made from the inventive formula is bread-like and contains none of the problems of prior low carbohydrate formulas.

### BACKGROUND OF THE INVENTION

Cereal based foods made from dough in the form of baked products such as bread is a universal food for the human population. Bread in the form of baked products including bread loaves, bread rolls, biscuits, appetizers, sweet confections, pizza crusts, pretzels and other materials are typically made from conventional formulations based primarily on high starch flour derived from wheat, rye, corn or other cereal grain. A variety of conventional bread formulations that vary in ingredients such as flour type, dairy products, eggs, sugar, salt, spices, flavorings and other additives have been developed over many years to provide a vast array of high starch, high carbohydrate bread products. Bread is a primary source of carbohydrate nutrition and can also contain amounts of fat, dairy, vitamins and minerals depending on formulatory strategy. Alternative bread dough and bread products have been developed over the years to solve certain consumer needs via technology.

For the purpose of health and weight control, low carbohydrate dough has attracted increasing attention. For certain individuals, high carbohydrate content can be either inconvenient or hazardous to health. The high carbohydrate content of many types of bread can pose an excessive caloric load resulting in weight gain. Further, the carbohydrate content of breads can pose a problem for individuals having either Type 1 or Type 2 diabetes and can be a significant problem in dietary control for other individuals. Various dietary plans have been proposed for both calorie conscious and health conscious individuals to reduce carbohydrate content of day-to-day diets. Such plans often include substituting a diet or low carbohydrate bread product for conventional breads.

Many proposed bread formulas remove flour made from grain seeds such as wheat or rye and substitute other fiber or soy flour, egg protein, or milk protein or other protein source entirely for the wheat flour or combinations of fiber and protein. In order to deal with the characteristic flavor of soy, the texture of non-nutritive fiber or certain flavor or texture characteristics of other protein substitutes, the formulations often contain a variety of other ingredients to provide improved taste. However, the result of such formulae is often to provide a product having “diet” taste or texture. These products are characterized by off flavors, distinctive soy flavor, or a gummy feel. Often, such products have a less than desirable texture that is sufficiently non-bready (minimal open cell structures) to provide a negative reaction in the consuming public.

Our review of current low carbohydrate breads on the market lead us to believe that no product, to date, provided a low carbohydrate bread, that combines a bread-like open cell structure and texture, along with a high quality bread-like flavor.

In view of the above, a substantial need exists to provide a novel formulation that can be made to produce a novel dough and bread. An improved bread or bread product can be made having low carbohydrate character, but having a quality open cell bready texture along with high quality nutrition and bread-like flavor. This product can be free of the poor texture or off-flavor characteristic of many “diet” low carbohydrate commercial products.

### SUMMARY OF THE INVENTION

We have found a novel dough composition for improved dough that can be used to produce a baked, high protein, low carbohydrate bread product. The formulation and process can be used to make low carbohydrate dough that can be used to manufacture bread and other bread-like products of high quality and consumer acceptance. The formulation leading to the dough and bread is characterized by a reduced or low nutritive carbohydrate content, bread-like open cell structure and a quality bread nutrition, texture and flavor. The dough comprises an aqueous leavened dispersion that comprises an effective but reduced amount of wheat flour for texture and flavor, an effective amount of gluten and modified wheat gluten. The amount of gluten is in excess of the flour content. The formulation uses an effective amount of a protein source along with an effective amount of an edible fiber to provide high protein content, low carbohydrate content and bready texture. We have also found that a small, but important amount, of a food grade reducing agent (effective to reduce sulfhydryl bonding in the gluten and protein sources) reduces the toughness of the formulation to provide both desirable flavor and texture properties. In addition to the above ingredients, the dough can contain an important amount of nutritive oil, cheese or other spices or flavorings to further provide nutrition and texture to the dough formulation. These materials in combination obtain a bready character from the dough, but maintain a low carbohydrate character in the presence of the other ingredients including the indigestible fiber, gluten and soy protein sources.

We have found that the combination of flour, edible fiber, gluten combined with a modified lightly hydrolyzed wheat gluten, whey protein concentrate and whole egg powder combined to provide the flavor and texture desired in an improved dough and bread product. The preferred formulations are characterized in a product that contains gluten combined with from about 0.1 to 0.67 parts of a modified wheat gluten, about 0.20 to 0.33 parts of a whey or modified whey and about 0.2 to less than 0.5 parts of a resistant starch fiber component per each part by weight of vital gluten. These amounts are based on the total amount of gluten in the product.

In the absence of these materials the common low carbohydrate material obtains a “gummy”, soft or sponge-like texture that is perceived to be “very moist” compared to a conventional bread product. Such conventional low carbohydrate breads or dough can bake to a crispy, cracker-like texture and exterior crust in a thermal oven but can fail to obtain any crust characteristic in a microwave preparation. The formulation of the low carbohydrate product of this invention provides viscoelastic and gas retention properties derived from wheat flour in conventional crust formulations. The formulation can provide a clean, dairy flavor profile while providing dough handling properties that enhance manufacturing characteristics and aid in obtaining open cell structure for the crumb after baking. These formulations achieve these properties with substantially reduced amounts of wheat flour.

We have found that the baked crust and bread products of the invention are bread-like with an open cell texture. Such breads are characterized by an improved specific volume when compared to prior art materials. Specific volume is defined as the volume per weight of the bread (mL-gm⁻¹). As the specific volume increases the bread achieves a lighter character, more bready texture and increased consumer acceptance. Specific volume is measured by dividing the volume of the baked product divided by the weight of the product. Specific volume is often expressed in milliliters per gram. Prior art materials having a less bready denser character typically have specific volume that ranges up to about 2.8 mL-gm⁻¹ or more often, from about 1.5 to 2.75 mL-gm⁻¹. We believe the specific volume characteristic of the invention is greater than 2.9 mL-gm⁻¹ preferably greater than 3.0 mL-gm⁻¹.

In order to obtain a useful formulation of materials, processing characteristics are important. Homogenous blending of the dry ingredients along with the proper sequence of addition into the mixing procedure will provide a dough system that delivers a pizza crust with a crust crispy, yet tender texture and open cell structure. Proper sheeting and other processing techniques are utilized to minimize that mechanical stress on the formulation during processing resulting in a pizza crust with the desirable characteristics. The addition of breadcrumbs to the exterior of the dough during sheeting and other processing steps can aid in obtaining open cell structure in the baked bread and can contribute to improved texture, crispness and taste.

### DETAILED DISCUSSION OF THE INVENTION

The novel dough and bread of the invention typically contain an effective amount of a gluten such as a vital gluten combined with a modified or hydrolyzed wheat gluten. The composition contains a controlled amount of a nutritive carbohydrate including flour and starch products, a non-nutritive dietary fiber, at least one protein source such as whey protein solids, a food grade reducing agent, leavening ingredients and a variety of other ingredients including sweeteners, flavorings, food grade gums, thickeners, fats and oils, cheese and water.

Typical bread formulas obtain gluten as a natural component of flour and other recipe ingredients. For the purpose of the invention, Applicants obtain a gluten derived from cereal grain. This gluten component that can be derived from a variety of natural plant sources acts as a primary texture component of the formulation. The gluten is a natural proteinaceous product with some carbohydrate character derived from natural sources having nutritive quality. Gluten is considered to be a proteinaceous substance of wheat that is naturally intermixed with the starch in the endosperm of the source grain. Gluten, in typical formulations, aids in retaining carbon dioxide produced during leavening or dough fermentation and enables the dough to retain the carbon dioxide in a manner that provides a porous and cellular structure to the dough. Gluten is typically prepared from natural plant sources including wheat and other related grains. Wheat gluten is a product that can be separated from the grain and is available on the market in a number of available sources. The preferred gluten is a gluten not substantially modified after isolation, that is not pretreated with chemical agents or enzyme processing. Gluten is used with an amount of modified or hydrolyzed gluten. The hydrolysis reduces the molecular weight. Enzyme, thermal or chemical (acid hydrolysis) processes can be used to make the modified or hydrolyzed gluten, a staple food ingredient. Increased water solubility does generally result from most enzymatically modified glutens, but there is often a large reduction in molecular weight of the enzyme-hydrolyzed glutens. In addition, the reaction products frequently contain low molecular weight peptides, including hydrophobic amino acids, which have an impact on flavor.

The formulations of the invention contain a controlled amount of a nutritive carbohydrate and an amount, in excess of the nutritive carbohydrate content of a non-nutritive carbohydrate component. The nutritive carbohydrates are typically natural sugar sweeteners, starchy materials characterized by a substantial quantity of alpha-glycan linkages in the carbohydrate structures. These structures are characteristic of flour and starch nutritive components. The non-nutritive carbohydrates typically in the form of non-nutritive, but edible, fibers include beta-glycan linkages between the carbohydrate monomers in the polysaccharide unit. Such non-nutritive materials are typically considered to be cellulosic derivatives in a fibrous form. The non-digestible cellulosic material comprise a dietary or nutritive fiber, included within such characteristics of a dietary non-nutritive fiber is a digestion resistant starch material which has dietary fiber properties but remains non-nutritive due to its characteristic. Dietary fibers typically contain cellulose, hemi cellulose, modified cellulose, non-nutritive protein, resistant starches, non-nutritive gums, carboxymethyl cellulose, methyl cellulose and other cellulosic derivatives, carrageen an gum, psyllium, etc.

The formulation of the invention can contain some proportion of a nutritive carbohydrate typically less than 10 wt % of the formulation, typically less than the fiber content and always less than the gluten content. Such nutritive starches and flours typically comprise simple sugars, flour, starch and derivatized starches such as wheat flour, rye flour, corn meal, and other natural starchy materials. Sugar sweeteners in the form of saccharides and disaccharides can be used in the formulation including glucose, high fructose corn syrup, sucrose, honey, etc.

In addition to the proteinaceous gluten content of the formulation, the dough formulations of the invention include a protein source such as whey, whey protein, whey solids, soy, egg or dietary protein that aids in obtaining a nutritive character to the formulation, but replaces some of the flour to obtain a nutritive dough formulation. Preferred formulations contain a whey protein material. Whey is a product of cheese making and can be processed into a useful product. Whey, sweet whey, whey protein concentrates can be used in the invention. The combination of the gluten, nutritive carbohydrate and non-nutritive fiber component with the protein source provides a bread dough material having a soft tender bread-like texture avoiding rubbery mouth feel, avoiding the sandy or grainy cell structure and the “diet” flavor. A variety of protein sources are available in proteinaceous products that can be used in the formulations of the invention. Such protein compositions include soy protein isolate, egg albumin, egg white protein, whey proteins, additional soluble and non-soluble proteins can be obtained from dairy sources, milk sources and soy sources.

Food grade reducing agents used in the invention to improve the texture and other organolystic characteristics of the bread product made from the dough formulation includes available food grade reducing agents. One characteristic group of food grade reducing agent are bisulfite reducing agents such as sodium or potassium bisulfite metabisulfite etc. Sulfite reducing agents can be used including reducing agents such as L-cysteine, glutathione and various salts or compositions containing such materials. Inactive yeast products can act as a source of reducing agent. Other reducing agents include such compositions as garlic enzyme, autolysed yeast, glutathione, cheese, proteolytic enzymes, and others. We believe the presence of reducing agents tends to soften the proteinaceous nature of the soy, milk or other protein source and the dairy protein source resulting in a softer, more acceptable texture in the bread product.

The lipid content of the dough material can be derived from both room temperature solid fatty materials and room temperature oil materials. Solid fats can include a variety of the shortening materials available on the market, lard, butter, margarine and blended products. Oily materials are also helpful in attaining the lipid content of the dough of the invention. Such oils typically comprises vegetable oils derived from a variety of sources, however, high quality soy bean oil appears to be a useful component in the dough of the invention. The oil is typically present in the formula in an amount from about 1 to about 10-wt %. The dough contains an increased amount of moisture relative to conventional dough and a specific controlled amount of sugar materials. Moisture is typically added to the ingredients by premixing the moisture with the ingredients and mixing the hydrated material into the dough or water can be added directly to the mixer with the dry ingredients.

Active yeast is a typical leavening agent for use in the formulation. Chemical leavening ingredients that can be used singly or in combination include the common chemical leaveners including sodium acid pyrophosphate, monocalcium phosphate, calcium sulfate, sodium carbonate, sodium bicarbonate and other similar materials. One important chemical leavener comprises an encapsulated sodium bicarbonate. The encapsulated nature of this material provides an extended leavening time that aids to develop the bready character in the dough as it cooks.

The dough materials of the invention can be formulated with a fiber or soluble fiber material. The benefits of fiber and soluble fiber are well known in improving health and promoting physiological properties. Fiber is known to, in some cases, reduce lipids in sensitive individuals. Both dietary fiber and soluble fibers are generally based on beta-glucan formats. The fibrous nature of soluble fibrous nature of the materials ordinarily results from the degree of branching and other molecular characteristics. Fiber can be obtained from a variety of sources and can take the form of generally cellulosic fibers, gums, soluble fibers and other forms. Non-nutritive or resistant starches can be used as a “fiber” source. Carrageenan gum is one important material that can improve frozen dough characteristics. This material is marketed under the name VISCARIN. Various gums and/or hydrocolloids can be used in formulating the doughs of the invention. Such doughs include carrageenan gums, alginate gums, xanthan gums and guar gums. Such material can be in the form of finely divided cellulosic powder or fiber, chemically modified cellulose including hydroxy alkyl cellulose, alkyl cellulose ethers such as methyl cellulose, hydroxy propyl cellulose and other food grade additive materials. Further, a number of natural gums based on cellulosic monomers can be used. Such gums include gums derived from food starch, guar gum, xanthan gum and similar materials. Other dough conditioner materials are dough additive materials can be used.

In addition, the dough can contain minor amounts of a variety of other baking additives including salt, spices, niacin, reduced iron, thiamin mononitrate, riboflavin, folic acid, malted barley flour, ascorbic acid, etc. Other additives that can be used in the bready materials of the invention include ingredients such as fruits and vegetables, nuts, soy based ingredients and materials added to fortify the formulations. One important additive ingredient that can be used to adapt a particular bread formulation for a particular end use involves the use of selected flavorings and seasonings. Using state of the art sensory technology, flavors preferred by young persons, teenagers, gen-Xers, baby boomers or senior citizens can be formulated. Such seasonings include both sweet and savory type seasonings used in a common consumer application. Seasonings can provide dairy flavor notes such as cream-type flavors, honey-type flavors, cheesy flavors, sour cream flavors, Mexican mole sauce characters, cream cheese and other related dairy type flavors. Additional flavors can include meat flavors or fish flavors including poultry, beef, pork, clam, shrimp, scallop, etc. Additional flavors include coffee flavor (in black, cream or latte flavors), smoky flavors, vanilla, chocolate, caramel and flavors that appeal to more of an adult taste including flavors of beer, distilled spirits, anchovy, etc. Additionally, whole grains or whole grain by-products can be used in the materials of the invention. Such materials include such products and by-products as corn meal, rice, wild rice or products thereof, minor grains, tapioca, sweet potato and taro by-products.

The cheese component typically comprises a blend of dairy protein, dairy fat, moisture and some amount of mineral character in a solid or semi-solid material. The primary intent of this patent application is to use a natural cheese made from pasteurized or unpasteurized dairy sources typically converted to a cheese using conventional cheese making technologies. However, the industry has developed a number of cheese materials that are equivalent to natural cheese made by blending dairy or non-dairy protein, dairy or non-dairy fat, inorganic supplements and other food grade materials into a material that is a substantial equivalent to natural cheese. This application should not be so narrowly construed that known cheese equivalents are excluded from the scope of the invention. The percentages disclosed herein are all based on the formulae content.

Cheeses used in the dough formulations can include Blue cheese, Mozzarella, provolone, Romano, Parmesan, jack and others. Commonly, cheeses in the form of shaved, crumbled or string form derived from mozzarella, Romano, Parmesan, provolone and whole milk or non-pasteurized cheeses can be used in the compositions of the invention. Cheeses, processed cheeses, cheese substitutes and cheese blends can be used both in the form of blended materials wherein two or more cheeses are blended and then applied to the crust. However, cheeses can also be added to the crust in layers without premixing.

Colorants and browning agents can also be used to enhance the attractiveness of the crusts of the invention. Products including Char SOL VSA, Meillose, both can impart a dark brown, golden brown, caramel color or tan character to a product without imparting undesirable flavors. Liquid smoke products can be used to provide browning if the smoky character of the color is not objectionable in the particular formulation. With the browning agent applied, the crust of the invention, when cooked at an appropriate microwave power setting on an appropriately shaped susceptor, obtains a pleasing crispy brown character. Conventional browning agents can aid in introducing a pleasing appearance and can help adjust the depth of color in the final crust. Conventional browning agents include sugar and amino acids react by heat developing Millard reaction which is the browning of the surface. The invention browning agent is an aqueous solution at 30 to 50% concentration.

One embodiment of the invention is making parbaked frozen pizza crusts as described below.

The product can be fortified using iron preparations, bioavailable calcium sources, vitamins, minerals, amino acids and other nutraceuticals. Vitamin and vitamin-like nutritional fortification can be obtained from Vitamin E sources, beta carotene sources, L-carnitine, etc.

The dough of the invention is made from the wet and dry ingredients using conventional technology. Preferably, the dry ingredients are mixed until uniform and then combined with fatty ingredients and water in an appropriate mixing vessel. The contents of the vessel are mixed until the dough achieves a characteristic dough texture and appearance. Typically, the dough of the invention is mixed in batches that can range from about 300 to about 1000 pounds per batch. Once the dough is adequately mixed, the contents of the mixture is transferred to a hopper portion of a sheeting device. While the dough is somewhat delicate, the dough can be sheeted to a final thickness of about 0.05 to about 0.20 inch using sheeting equipment requiring one or more passes until the dough reaches the appropriate thickness. Typically, the thickness of the dough is obtained through a series of reducing stations resulting in the reduction, in each pass, in thickness of about 0.01 to 0.05 inch per station until the final sheeting thickness is achieved. Once sheeted to the appropriate thickness, the sheeted dough is docked conventionally introducing about 100 to about 200 docking locations per square foot of sheeted dough. The docked sheet is then transferred to a cutting station at which dough circles having a radius of 2 inches, 3 inches, 4 inches, 5 inches, 6 inches or 7 inches or greater can be cut using conventional sheet cutting technology. The cut dough circles are then parbaked for about 60 to about 300 seconds at about 350 to about 500° F. to obtain a parbaked crust. The parbaked crusts are then appropriately packaged and frozen at −30° F. for 45 minutes and are then stored at <0° F. until used. During processing, vital wheat gluten is used where flour would be used to aid in dough handling, transfer and all dough manipulation steps along the processing line. Bread crumbs are added at an amount of about 3 to about 10 grams of bread crumbs per square foot of dough surface on the top of the sheeted dough just before the final reducing station in the sheeting step.

The crusts or products can be sold as is to consumers, food preparation businesses, commercial pizza making consumers and other locations for the addition of pizza sauce, cheese, condiments, meats and other materials for baking into a final pizza product. Additionally, the parbaked and frozen crusts can be taken, in frozen form, and to that product can be added appropriate sauces, cheeses, condiments, vegetables and meat products to obtain a desired pizza topping. Such a product can then again be refrozen, packaged and sold as a pizza product, both in the retail consumer market and in the institutional pizza market. The sauces, cheeses, condiments, vegetables and meats used in the pizzas of the invention are conventional pizza ingredients.

The characteristic formulations are shown as follows:

### Formulations

Low Carbohydrate Formulae

| | | Embodiment | Embodiment |
|---|---|---|---|
| | Useful | 1 | 2 |
| Ingredient | wt % | wt % | wt % |
| Vital Gluten | 10-50 | 15-40 | 24-30 |
| Modified wheat gluten | 0.1-20 | 0.2-15 | 1-10 |
| Nutritive flour or starch | 3-15 | 5-15 | 6-10 |
| Non-nutritive Dietary Fibers | 2-15 | 3-15 | 8-12 |
| Protein Sources (whey, whey | 1-25 | 5-15 | 6-12 |
| products, soy, egg, dairy) | | | |
| Food grade reducing agent | 0.1-3 | 0.2-2 | 0.3-1 |
| Active yeast leavening agent | 1-5 | 1.5-4 | 0.3-1 |
| Nutritive Sweetener | 0-8 | 1.5-4 | 2-3 |
| Non-yeast leavening | 0-3 | 0.1-1 | 0.2-0.8 |
| Spices flavorings | 0-3 | 0.1-2 | 0.2-1.5 |
| Food grade gums and thickeners | 0-3 | 2-2 | 0.1-1.5 |
| Fats and Oil | 2-17 | 3-15 | 4-13 |
| Cheese | 0-5 | 0-4 | 0-3 |
| Dough Conditioner | 0.01-1 | 0.02-0.08 | 0.03-0.5 |
| Water | 20-50 | 25-40 | 25-35 |

### EXAMPLES 1-11

### Working Examples

| | Example | Example | Example | Example | Example | Example | Example | Example | Example | Example | Example |
|---|---|---|---|---|---|---|---|---|---|---|---|
| | 1(4) | 2(5) | 3(6) | 4(1) | 5(2) | 6(3) | 7 | 8 | 9 | 10 | 11 |
| Ingredient | (%) | (%) | (%) | (%) | (%) | (%) | (%) | (%) | (%) | (%) | (%) |
| Vital Gluten | 17.01 | 17.01 | 16.84 | 19.04 | 16.70 | 19.93 | 22.31 | 22.49 | 23.11 | 17.30 | 19.04 |
| Water | 47.26 | 47.26 | 46.79 | 29.99 | 47.35 | 43.48 | 29.52 | 32.31 | 31.83 | 36.39 | 29.99 |
| Modified Gluten | 4.57 | 4.57 | 4.53 | 7.18 | 2.49 | 0.00 | 6.00 | 6.05 | 6.21 | 6.53 | 7.18 |
| Soy Protein | 3.06 | 3.06 | 3.03 | 0.00 | 4.98 | 0.00 | 0.00 | 0.00 | 0.00 | 0.00 | 0.00 |
| Isolate | | | | | | | | | | | |
| Modified Starch | 7.13 | 7.13 | 7.06 | 8.98 | 7.47 | 7.25 | 9.35 | 9.43 | 9.69 | 8.16 | 8.98 |
| Egg Powder | 2.04 | 1.02 | 0.00 | 0.90 | 1.99 | 5.43 | 0.00 | 0.94 | 0.69 | 0.82 | 0.90 |
| Soy Protein | 0.00 | 0.00 | 0.00 | 0.00 | 3.99 | 3.62 | 0.00 | 0.00 | 0.00 | 0.00 | 0.00 |
| Isolate | | | | | | | | | | | |
| Veg. Soy Oil | 3.61 | 3.61 | 3.57 | 6.36 | 3.54 | 5.43 | 4.73 | 4.77 | 4.90 | 5.78 | 6.36 |
| Sugar | 0.71 | 0.71 | 0.71 | 0.90 | 0.50 | 0.72 | 0.93 | 0.94 | 0.97 | 0.82 | 0.90 |
| Yeast- | 1.30 | 1.30 | 1.29 | 2.30 | 2.24 | 1.09 | 1.71 | 1.72 | 1.77 | 2.09 | 2.30 |
| compressed/ | | | | | | | | | | | |
| cream/instant | | | | | | | | | | | |
| Active Yeast | | | | | | | | | | | |
| Salt | 1.02 | 1.02 | 1.01 | 1.44 | 0.7 | 1.09 | 1.34 | 1.08 | 1.11 | 1.31 | 1.44 |
| Shortening Chips | 2.79 | 2.79 | 2.76 | 4.92 | 2.74 | 2.54 | 3.66 | 3.69 | 3.79 | 4.47 | 4.92 |
| Flour | 6.11 | 6.11 | 6.05 | 8.08 | 3.99 | 3.62 | 8.01 | 8.08 | 8.30 | 7.34 | 8.08 |
| Baking Powder, | 0.31 | 0.31 | 0.30 | 0.54 | 0.30 | 0.00 | 0.40 | 0.40 | 0.42 | 0.49 | 0.54 |
| single act | | | | | | | | | | | |
| Flow Processing | 0.02 | 0.02 | 0.02 | 0.04 | 0.02 | 0.00 | 0.03 | 0.03 | 0.03 | 0.03 | 0.04 |
| Additive | | | | | | | | | | | |
| Inactive Yeast | 1.02 | 1.02 | 1.01 | 1.80 | 1.00 | 0.22 | 1.34 | 1.35 | 1.38 | 1.63 | 1.80 |
| Whey Protein | 2.04 | 3.06 | 5.04 | 7.18 | | 0.00 | 10.69 | 6.73 | 5.53 | 6.53 | 7.18 |
| Concentrate | | | | | | | | | | | |
| Cheese flavor | | | | 0.36 | | 0.00 | | | 0.00 | 0.00 | 0.00 |
| Gum | | | | 0.00 | | 1.45 | | | 0.00 | 0.00 | 0.00 |
| Cheese | | | | | | 3.63 | | | 0.28 | 0.33 | 0.36 |
| Spices | | | | | | 0.50 | | | | | |

Note
number in parenthesis (1) indicates original formulation

One aspect of the improved cereal based product of the invention is its texture. The texture of the material is an “open cell” texture characteristic of cereal based or flour based bread products. The bread products typically identified by consumers as high quality bread materials have an open cell structure and, as a result, have a relatively low density and an appearance suggesting a number of open cells in the structure of the bready material. The materials identified by consumers as being less desirable bread products tend to have a texture free of large numbers of open cells, are more dense, are more “gummy” and are less bread-like in character. One method of distinguishing open cell bready character from the conventional low carbohydrate “diet” bread products involves the measurement of the specific volume of the dough. Specific volume is defined as the volume of the dough per unit gram of the product.

Specific volume is measured by AACC method 10-05 “Guidelines for Measurement of Volume by Rapeseed Displacement”. The volume meter was calibrated and used as described in the method. After baking, pizza having crusts of the invention had their toppings removed, and sauce wiped off. The crusts were then weighed. After being weighted, the crusts were paired, placed face to face, and positioned in the volume meter. To calculate specific volume, after crust volume was recorded in cubic centimeters (ml), this volume value was divided by the crust weight in grams.

We have found that the specific volume of the products of the invention are typically greater than about 2.85 and more typically greater than 3.0 mL-gm⁻¹. The following table lists our experimental findings regarding the products of the invention and competitor products. Please note that the Competitor 1 product and the Competitor 2 product in the table are the same products as shown in the test data below as Competitor 1 and Competitor 2 products. Competitor 3 product was not tested in the test panel data listed below.

TABLE 1
Specific Volume of the Crusts of the invention

| | Average Specific Volume |
|---|---|
| Crust tested | of Four crusts |
| Pizza Crust of the Invention | 3.05 |
| Competitor 1 | 2.78 |
| Competitor 2 | 2.42 |
| Competitor 3 | 1.78 |

Only the crust of the invention was selected by a taste panel as characterized by a bready texture.

A project to conduct a product study of low carbohydrate dough/bread and to compare known commercial materials.

### Methodology

In a pre-recruited central location taste test, 125 qualified consumers evaluated three of the five test pizzas. The order of tasting was rotated to prevent order bias. Qualifications of a qualified consumer were males or females, ages 21 to 64 with no more than 40% male. The consumers were qualified by a standard security screen, had no participation in research during the past three months, must be following a low carbohydrate diet or restricting their intake of carbohydrates, i.e., carbohydrate conscious consumers, must be positive to the general description of a low carbohydrate pizza and have no food or allergy restrictions. With a total of 125 consumers, the results were approximately 75 evaluations for each of the five pizzas over two days. (Judging was on a 1 to 9 point scale—8, 9 like extremely/very much—6, 7 like slightly/moderately—neither like nor dislike-to-dislike 5, 4, 3, 2, 1)

In summary, as shown below, the low carbohydrate pizza crust of the invention performs better than the alternative Schwan's regular crust pizza (TNT) on most dimensions and is at parity on nearly all of the remaining. There are only three dimensions where Schwan's TNT holds a slight edge: sweetness and spiciness of the sauce and the amount of pepperoni. Criteria not relate to the crust. The low carbohydrate pizza crust of the invention performed significantly better than the Competitor 1 product. The low carbohydrate pizza crust of the invention is superior to Competitor 2 on all key dimensions and at parity on most of the others. The only areas of crust character strength for Competitor 2 is sweetness of the crust.

### Taste Expectations of Low Carbohydrate Pizza

The taste expectation for low carbohydrate pizza was rated on a 9 point rating scale, where 9 indicated “Like it extremely” and 1 indicated “Dislike it extremely”. The ratings were extremely/very much (rating of 8 or 9); like moderately/slightly (rating of 6 or 7); neither like or dislike/dislike (rating of 1, 2, 3, 4 or 5).

### Taste Expectations of Specific Low Carbohydrate Pizza Before Trying

Taste expectations of specific low carbohydrate pizzas, the following ratings resulted. For any arbitrary low carbohydrate pizza crust, the panel did not have high expectations. About 68% expected to like the crust only moderately and 12% expected to dislike it. Only 20% expected to like the crust.

Uppercase letters indicate significance at 95% confidence level, lowercase at 90% confidence level; Comparisons tested ABC, AD, BD, CD, AR, BE, CE. The crust of the invention (A) was rated as 5% like it extremely and 43% like it very much. Schwan's TNT (B) was rated as 1% Like it extremely and 34% Like it very much. Schwan's French Bread (C) was rated as 1% Like it extremely and 28% Like it very much. Competitor 1 (D) was rated as 1% Like it extremely and 17% Like it very much. Competitor 2 (E) was rated as 3% Like it extremely and 36% Like it very much.

In the next rating, Competitor 1 and Competitor 2 crusts were defined as follows:

### Competitor 1

Competitor 1 crust appears to be a sheeted raw dough product that “rises” in the oven or microwave when prepared by the end consumer. The product has a dense, fine grained cell structure, the internal crumb upon baking or microwave cooking is “gummy”, soft or sponge like in texture that is very moist. The crust delivers a slight crisp when prepared in the oven, but does not crisp when prepared on the susceptor in the microwave.

Crust ingredients include water, wheat protein, whole wheat flour, corn starch, inulin, wheat fiber, soybean oil, soy flour, contains 2% or less of yeast, L-cysteine, salt, citric acid, lecithin, corn syrup solids, maltodextrin, natural and artificial flavor, thiamine hydrochloride, tricalcium phosphate, L-lysine monohydrochloride, ammoniated glycyrrhizin and sucralose.

### Competitor 2

Competitor 2 crust appears to be a sheeted raw dough product that “rises” in the oven and does not have preparation instructions for the microwave. The product has a dense, fine grain cell structure with a slight crispness to the crust when prepared in the oven. The crumb of the product has a fine grained cell structure, the internal crumb upon baking “gummy”, soft or sponge like in texture that is moist when compared to a traditional pizza.

Crust ingredients include water, vital wheat gluten flour, soy flour, salt, baking powder, olive oil, yeast, garlic powder and spices.

### Comparison to Expectations

In comparison to expectations, the following ratings resulted. Ratings were on a 5 point scale, where 5 indicated Much better than expected and 1 indicated Much worse than expected. Uppercase letters indicate significance at 95% confidence level, lowercase at 90% confidence level; columns tested ABC, AD, BD, CDE, AE, BE and CE.

TABLE 2

| | Much | Somewhat | About the | Somewhat | Much |
|---|---|---|---|---|---|
| | better than | better than | same as | worse than | worse than |
| | expected | expected | expected | expected | expected |
| The crust of | 34% CD | 33% C | 18% | 14% | 1% |
| the invention | | | | | |
| (A) | | | | | |
| Pizza Crust | 28% | 30% c | 21% | 16% | 5% |
| Supplier (B) | | | | | |
| French | 14% | 18% | 26% | 33% A Be | 8% A |
| Bread | | | | | |
| Supplier (C) | | | | | |
| Competitor 1 | 9% | 32% C | 28% | 24% | 5% |
| Competitor 2 | 23% | 27% | 22% | 19% | 8% A |

### Taste Liking Measures

In comparison to expectations, the following ratings resulted. Ratings were on a 9 point scale, where 9 indicated Like it extremely and 1 indicated Dislike it extremely. Uppercase letters indicate significance at 95% confidence level, lowercase at 90% confidence level; columns tested ABC, AD, BD, CDE, AE, BE and CE.

TABLE 3

| | Overall | Crust |
|---|---|---|
| The crust of the | 7.1 bcDe | 7.1 BCDE |
| invention (A) | | |
| Pizza Crust | 6.6 CD | 6.2 cD |
| Supplier(B) | | |
| French Bread | 5.7 | 5.3 |
| Supplier (C) | | |
| Competitor 1 | 5.9 | 5.6 |
| Competitor 2 | 6.6 C | 6.1 C |

### Aftertaste of Crust

Ratings were on a 5 point scale where 5 indicates Very pleasant aftertaste and 1 indicates Very unpleasant aftertaste. Uppercase letters indicate significance at 95% Confidence Level, lowercase at 90% Confidence Level; columns tested ABC, AD, BD, CD, AE, BE and CE.

TABLE 4

| | | | Neither | | | |
|---|---|---|---|---|---|---|
| | | | pleasant | | | |
| | Very | Somewhat | nor | Somewhat | Very | No |
| | pleasant | pleasant | unpleasant | unpleasant | unpleasant | aftertaste |
| | aftertaste | aftertaste | aftertaste | aftertaste | aftertaste | at all |
| The crust of | 6% | 32% B | 33% | 22% | 3% | 5% |
| the invention | | | | | | |
| (A) | | | | | | |
| Pizza Crust | 15% ae | 17% | 37% | 24% | 2% | 5% |
| Supplier (B) | | | | | | |
| French Bread | 11% | 22% | 38% | 33% E | 5% | 1% |
| Supplier (C) | | | | | | |
| Competitor 1 | 8% | 24% | 32% | 24% | 7% | 4% |
| Competitor 2 | 5% | 34% B | 34% | 15% | 3% | 8% C |

### Crispness/Doughiness of Crust

Rated on a 5 point Just about right scale. Uppercase letters indicate significance at 95% Confidence Level, lowercase at 90% Confidence Level; columns tested ABC, AD, BD, CD, AE, BE and CE.

TABLE 5

| | Much/Somewhat | Just about | Much/Somewhat |
|---|---|---|---|
| | too much crispy | right | too doughy |
| The crust of | 18% bDE | 81% BCDE | 1% |
| the invention | | | |
| (A) | | | |
| Pizza Crust | 9% | 46% | 45% AC |
| Supplier (B) | | | |
| French Bread | 14% E | 57% E | 29% A |
| Supplier (C) | | | |
| Competitor 1 | 7% | 46% | 47% AC |
| Competitor 2 | 3% | 29% | 68% ABC |

### Tenderness/Toughness of Crust

Rated on a 5 point Just about right scale. Uppercase letters indicate significance at 95% Confidence Level, lowercase at 90% Confidence Level; columns tested ABC, AD, BD, CD, AE, BE and CE.

TABLE 6

| | Much/Somewhat | Just about | Much/Somewhat |
|---|---|---|---|
| | too tender | right | too tough |
| The crust of | 4% | 91% BCDE | 5% |
| the invention | | | |
| (A) | | | |
| Pizza Crust | 11% a | 56% | 33% ACDE |
| Supplier (B) | | | |
| French Bread | 20% A | 66% | 14% A |
| Supplier (C) | | | |
| Competitor 1 | 28% AB | 54% | 18% A |
| Competitor 2 | 26% AB | 57% | 17% A |

### Chewiness of Crust

Rated on a 5 point Just about right scale. Uppercase letters indicate significance at 95% Confidence Level, lowercase at 90% Confidence Level; columns tested ABC, AD, BD, CD, AE, BE and CE.

TABLE 7

| | | | Not nearly/Not |
|---|---|---|---|
| | Much/Somewhat | Just about | quite chewy |
| | too chewy | right | enough |
| The crust of | 4% | 78% BCDE | 18% |
| the invention | | | |
| (A) | | | |
| Pizza Crust | 33% AC | 46% | 21% |
| Supplier (B) | | | |
| French Bread | 18% A | 51% | 30% aDE |
| Supplier (C) | | | |
| Competitor 1 | 38% AC | 49% | 14% |
| Competitor 2 | 47% AbC | 40% | 14% |

### Ratio of Crust to Toppings

Rated on a 5 point Just about right scale. Uppercase letters indicate significance at 95% Confidence Level, lowercase at 90% Confidence Level; columns tested ABC, AD, BD, CD, AE, BE and CE.

TABLE 8

| | Much/Somewhat | | |
|---|---|---|---|
| | too crust much | | Much/Somewhat |
| | relative to | Just about | too many toppings |
| | topping | right | relative to crust |
| The crust of | 10% | 73% CDE | 16% Cd |
| the invention | | | |
| (A) | | | |
| Pizza Crust | 7% | 68% Cd | 24% CD |
| Supplier (B) | | | |
| French Bread | 84% ABDE | 14% | 1% |
| Supplier (C) | | | |
| Competitor 1 | 39% AB | 54% C | 7% c |
| Competitor 2 | 23% AB | 56% C | 21% C |

In all cases, in evaluating the crust characteristics of the crust of the invention, in comparison to other crusts and closest competitor crusts, representative consumers detected a substantially improved organolystic quantities indicating better mouthful, texture, doughiness, etc. in the invention.

The forgoing provides a disclosure of the developments in this cereal/protein/fiber based product. Since many embodiments can be made within the concept, spirit and scope of the invention, the invention is embodied in the claims hereafter appended.

1. A dough composition for producing a baked, high protein, low carbohydrate dough, the dough comprising an aqueous leavened dispersion comprising:
(a) less than about 10 wt % flour;
(b) about 5 to 50 wt % of a combination of gluten and a modified wheat gluten, wherein the gluten comprises about 0.01 to 0.67 parts of the modified wheat gluten per each part by weight of gluten;
(c) about 1 to 20 wt % of a protein source comprising a soy protein, a milk protein, an egg protein or mixtures thereof;
(d) greater than about 2 wt % of a food grade but substantially non-nutritive fiber; and
(e) about 0.01 to 5 wt % of a source of food grade reducing agent;
wherein the dough provides a reduced or low carbohydrate content and a baked open cell structure; and when baked forms a product having a specific volume greater than about 2.8 cc/gm and is bread-like.

2. The dough of claim 1 wherein the milk protein is a whey protein.

3. The dough of claim 1 wherein the modified gluten is a hydrolyzed gluten.

4. The dough of claim 1 wherein the dough comprises loss than 10 wt % digestible carbohydrate, at least 30 wt % total protein and wherein the ratio of protein to digestible carbohydrate is greater than 2:1.

5. The dough of claim 4 wherein the fiber comprises a resistant starch and the specific volume is greater than 3.0 cc/gm.

6. The dough of claim 1 wherein the protein source comprises an egg protein.

7. The dough of claim 1 additionally comprising about 0.1 to 5 wt % cheese.

8. The dough of claim 1 additionally comprising about 0.1 to 10 wt % oil.

9. The dough of claim 1 additionally comprising about 0.1 to 3 wt % of a spice or flavoring.

10. (canceled)

11. The dough of claim 2 wherein the dough comprises about 0.2 to 0.33 parts of whey per part of vital gluten.

12. The dough of claim 5 wherein there is about 0.2 to 0.5 parts of resistant starch per part of vital gluten.

13. The dough of claim 1 wherein the reducing agent comprises about 0.01 to 2 wt % of a sulfhydryl reducing agent.

14. The dough of claim 1 wherein the reducing agent comprises about 0.01 to 2 wt % of a source of glutathione.

15. The dough of claim 1 wherein the reducing agent comprises about 0.01 to 2 wt % of a inactive yeast.

16. A baked, high protein, low carbohydrate food product comprising the product of baking the dough of claim 1.

17. The product of claim 16 comprising a pizza crust.

18. A dough composition for producing a baked high protein, low carbohydrate dough, the dough comprising an aqueous leavened dispersion comprising:
(a) about 0.1 to about 10 wt % flour;
(b) about 5 to 50 wt % of a combination of a vital wheat gluten and a modified wheat gluten, wherein the gluten comprises about 0.01 to 0.67 parts of the modified wheat gluten per each part by weight of gluten;
(c) about 1 to 20 wt % of a protein source comprising a blend of a whey protein concentrate and whole egg powder;
(d) about 2 to about 15 wt % of a food grade resistant starch comprising a non-nutritive carbohydrate; and
(e) about 0.01 to 5 wt % of a source of a food grade reducing agent;
wherein the dough provides a baked open cell structure and low carbohydrate bready dough that when baked forms a product having a specific volume greater than about 2.8 cc/gm.

19. (canceled)

20. The dough of claim 18 wherein the dough comprises about 0.2 to about 0.33 parts of a modified whey powder per part of vital gluten.

21. The dough of claim 18 wherein there is about 0.2 to 0.5 parts of a resistant starch edible fiber per each part by weight of vital gluten.

22. The dough of claim 18 wherein the dough comprises less than 10 wt % digestible carbohydrate, at least about 30 wt % total protein wherein the ratio of protein to digestible carbohydrate is greater than 2:1 and the specific volume is greater than 3.0 cc/gm.

23. The dough of claim 18 additionally comprising about 0.1 to 5 wt % of a cheese.

24. The dough of claim 18 additionally comprising about 0.1 to 10 wt % of a fat, an oil or mixtures thereof.

25. The dough of claim 18 wherein the reducing agent comprises about 0.01 to 2 wt % of a sulfhydryl reducing agent.

26. The dough of claim 18 wherein the reducing agent comprises about 0.01 to 2 wt % of a source of glutathione.

27. The dough of claim 18 wherein the reducing agent comprises about 0.01 to 2 wt % of an inactive yeast.

28. A baked low protein carbohydrate food product comprising the food product of baking the dough of claim 18.

29. The product of claim 18 comprising a pizza crust.
